(19) United States
(12) Patent Application Publication
(10) Pub. No.: US 2026/0050462 A1
(43) Pub. Date: Feb. 19, 2026

(54) ACCELERATING LIVE PARTITION MOBILITY (LPM)

(71) Applicant: INTERNATIONAL BUSINESS MACHINES CORPORATION, ARMONK, NY (US)

(72) Inventors: VAMSHIKRISHNA THATIKONDA, Hyderabad (IN); Sanket Rathi, Hyderabad (IN); Naveen Karthick Chandrasekaran, Bangalore (IN)

(21) Appl. No.: 18/805,585

(22) Filed: Aug. 15, 2024

(51) Int. Cl. G06F 9/455

(52) U.S. Cl. CPC G06F 9/45558; G06F 2009/45562; G06F 2009/45583

(57) ABSTRACT

A method, computer system, and computer program product are provided for non-disruptive live partition mobility (LPM). An orchestrator verifies source profile of virtual machine (VM) indicates source VM instant live partition mobility (LPM) capable. If so, orchestrator instructs source computer hypervisor to initiate handshake with destination computer hypervisor. When instant LPM capable VM is activated, source computer hypervisor enables source virtual input/output server (VIOS) to initiate continuous pre-transfer of source VM memory pages to virtual input/output server (VIOS) on destination computer. Received source VM memory pages are written to local cache on destination computer. Pre-transferred source VM memory pages are least recently modified memory pages. Upon initiating LPM event the hypervisor receives an instruction to build a destination VM. In parallel to build of destination VM, remaining source VM memory pages are sent to the destination computer. Upon completion of the build of the destination VM, terminating the LPM event.

### BACKGROUND

The present invention relates generally to the field of computing, and more particularly to live partition mobility.

Customers running business-critical workloads cannot tolerate downtime, even though the downtime may be needed to apply necessary software updates or to replace a hardware component. Technology exists to create virtual partitions on computer systems to run critical workloads, and to seamlessly migrate those virtual partitions to other computer systems when needed. However, in currently known technology the partition migration only begins in response to an administrator command. In virtual partitions having a large memory footprint, such as an active in-memory database, the migration process is lengthy and impacts performance and response time.

It would be advantageous to pre-transfer memory pages of the source virtual machine (VM) to accelerate the execution of the live partition migration process, thereby improving application response time and performance.

### SUMMARY

Embodiments of the present invention disclose a computer-implemented method, computer system, and a computer program product to perform non-disruptive live partition mobility (LPM). An orchestrator verifies that the source profile of the virtual machine (VM) indicates the source VM is instant live partition mobility (LPM) capable. If so, the orchestrator instructs the source computer hypervisor to initiate a handshake with the destination computer hypervisor. When an instant LPM capable VM is activated, the source computer hypervisor enables the source virtual input/output server (VIOS) to initiate continuous pre-transfer of source VM memory pages to the virtual input/output server (VIOS) on the destination computer. The received pre-transfer source VM memory pages are written to the local cache on destination computer. Pre-transferred source VM memory pages are least recently modified memory pages. Upon initiating the LPM event the hypervisor receives an instruction to build a destination VM. As part of building the destination VM, the memory image from the local cache is recreated for the VM. In parallel to the build of the destination VM, remaining source VM memory pages are sent to the destination and written directly to the destination VM. As the remaining source VM memory pages are written to the destination VM, any existing duplicate memory page is invalidated in the local cache, thereby ensuring that a stale copy of a memory page is not written from the cache to the destination VM. Upon completion of the build of the destination VM, the LPM event is terminated.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of an example operating environment before and after live partition mobility event according to at least one embodiment; and

FIG. 3 is an operational flowchart illustrating a live partition mobility operation according to at least one embodiment.

### DETAILED DESCRIPTION

The following described exemplary embodiments provide a computer system, computer-implemented method, and computer program product for accelerating live partition mobility.

Enterprise computer installations typically host business-critical workloads that require continuous or near-continuous uptime. Additionally, to maximize their return on investment in technology, minimize the requirement for computer room floor space, and reduce power consumption, customers tend to select physical computers that can be configured as multiple virtual environments, referred to as logical partitions (LPAR), or virtual machines (VM). Some VM environments also support a live partition mobility (LPM) facility. The LPM facility enables VMs running active workloads to migrate, without downtime, from one VM in a computer host to another VM in the same or different computer host. Typical workloads include an operating system, one or more applications, and one or more database management systems (DBMS), especially an in-memory DBMS. Embodiments of the present invention can be practiced in any computing environment that implement both VM and the LPM architectures. However, the PowerVM® and IBM® LPM architectures are used in teaching the various embodiments of the present invention. (PowerVM® and IBM® are a registered trademarks of International Business Machines Corporation in the United States).

In general, a VM environment includes the logical partition and the physical and virtual resources assigned to it. Such resources include computer processors and state (e.g., percent utilization, idle, offline), memory, attached virtual devices, and any workload assigned to and/or executing in the VM. An orchestrator manages the operation one or more physical computers to which it is attached, including all the VMs that are defined on each of the physical computers.

The orchestrator also coordinates various actions associated with LPM such as discovering the configuration profile of the source VM, and validating the compatibility of the destination computer to be the target of the LPM event. The LPM event includes transferring the memory contents of the source VM using a virtualization control program, also referred to as a hypervisor, in cooperation with a Virtual I/O Server (VIOS) which has access to the network between the source VM and the destination VM.

The VIOS is a specialized VM that facilitates virtualization and management of real physical hardware resources to the other VMs that it controls. The VIOS also provides an interface between the orchestrator and the hypervisor. There is a VIOS defined on each physical computer that the orchestrator manages, thereby ensuring a communication path among the VMs, the hypervisor, the VIOSs and the orchestrator.

As practiced in the current technology, that is, LPM environments not having embodiments of the present invention installed, the process of transferring the source VM memory pages to a destination VM begins only when the system administrator initiates the LPM command at the orchestrator. The source VM memory pages are transferred directly to the destination VM over the network, where the memory pages are immediately inserted into the destination VM. The LPM completion time, and therefore application availability and performance, is heavily dependent on factors such as the amount of memory that is configured to the VM, how active the workload is, and the available network bandwidth. For example, highly active workloads, such as an in-memory DBMS typically require that the LPM resend some of the same pages to the destination VM due to how frequently the in-memory DBMS updates its memory pages.

Embodiments of the present invention improve current LPM technology and address its shortcomings by providing a cache that is local to the destination VIOS. Certain source VMs that the business enterprise considers critical and require expedited availability are marked as instant LPM capable in the VM's configuration profile. A system administrator may make this designation through a command line interface or graphical user interface on an orchestrator that manages the VM. For instant LPM capable VMs, pre-transfer of certain source VM memory pages is initiated on startup of the source VM, even prior to initiating the LPM event. The source VM memory pages that are pre-transferred are those the hypervisor identifies as dormant, i.e., least recently modified. In general, a hypervisor is a layer that abstracts the physical computer hardware. In the present invention, the hypervisor is a firmware layer between the VMs and their hosted operating systems, and the physical hardware. Therefore, the hypervisor maintains various page tables to track physical memory pages by page status, VM ownership, and effective memory location. Further discussion of various aspects of the hypervisor layer and how memory management is performed are not explored here, as they may vary, depending on the implementation of the particular architecture.

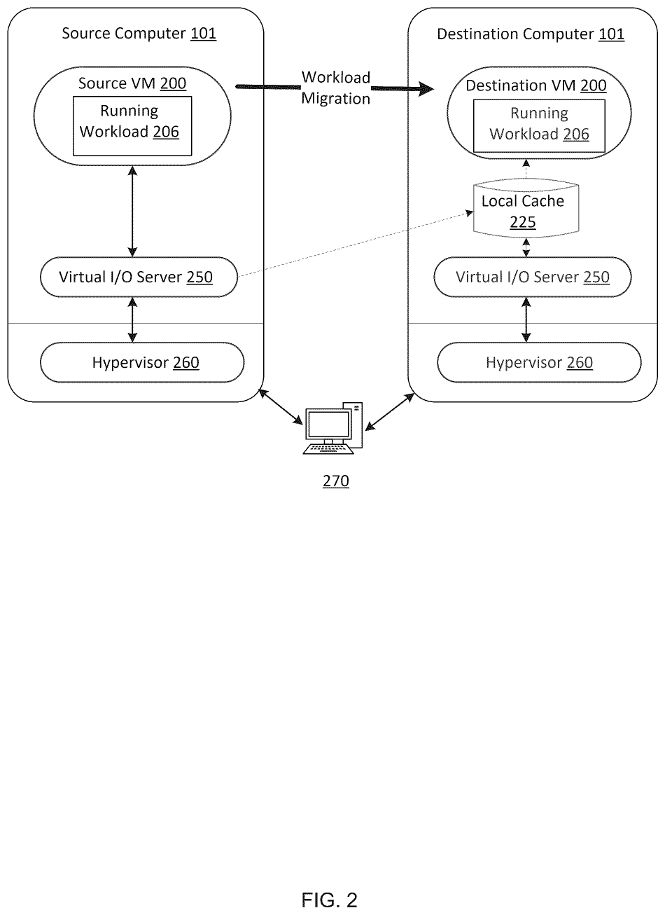

In contrast to the current LPM technology, the pre-transferred memory pages are not immediately inserted into the destination VM but are stored in the local cache on the destination VIOS, as will be discussed with reference to FIG. 2. This reduces disruption to the applications executing on the source VM, as the pre-transfer occurs a few memory pages at a time and tends not to saturate the network. When the actual LPM event is initiated, the LPM process creates the logical framework of the destination VM, begins building the destination VM memory pages from the local cache, and in parallel transfers any remaining source VM memory pages (that includes memory pages those were not transferred or memory pages those are modified after transfer) to the destination VM.

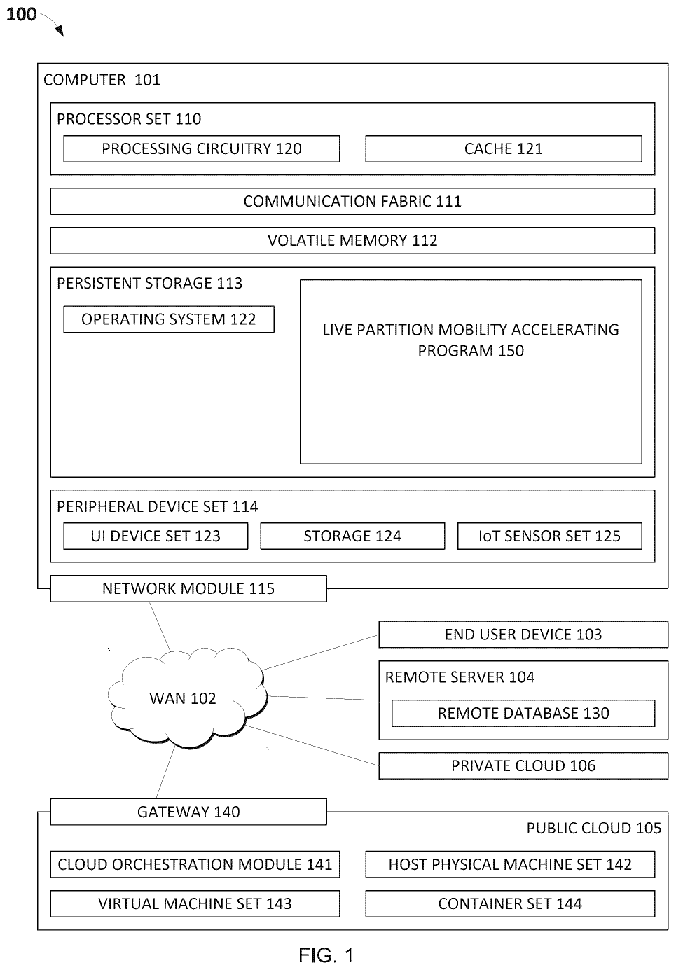

Referring to FIG. 1, a computing environment 100 according to at least one embodiment is depicted. Computing environment 100 contains an example of an environment for the execution of at least some of the computer code involved in performing the inventive methods, such as the live partition mobility (LPM) accelerating program (program) 150. In addition to the program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, also referred to as the administrative computer or orchestrator, host physical machine set 142, virtual machine set 143, and container set 144. Furthermore, despite only being depicted in computer 101, the program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 is a schematic block diagram of an example LPM environment according to at least one embodiment.

As used herein, the LPM environment refers to a source computer 101 and a destination computer 101, both of which must be LPM capable and comply with all requirements of whichever vendor LPM architecture is implemented. The LPM environment further includes at least one source VM 200 and at least one destination VM 200, at least one VIOS 250 on the source computer 101 and at least one VIOS 250 on the destination computer 101, and an orchestrator 270. The source computer 101 and the destination computer 101 are high level representations of the computer 101 of the networked computing environment of FIG. 1.

The destination computer 101 includes a local cache 225 to receive the pre-transfer of the source VM 200 memory pages pending initiating the LPM event and the subsequent transfer of the additional memory pages during the LPM event. For best performance, the local cache 225 is a high-speed persistent cache device dedicated for the purpose of storing source VM memory pages, such as a nonvolatile memory express device (NVMe). However, as storage device technology improves, other devices may provide better performance and may be used as the local cache 225.

The local cache 225 capacity is at least the same as the size of the memory pages it will contain. Although not shown, there can be a local cache 225 configured on the source computer 101 as well. This would make a reverse LPM event back to the source VM 200 possible. However, the present invention does not remove pre-invention LPM behavior, which remains available if preferred.

Although only one source/destination VM pair is shown, other configurations are possible, depending on any limitations of the LPM architecture implementation. For example, in some embodiments, the local cache 225 may be of sufficient size to support partitioning to contain the memory pages from more than one destination VM 200. Additionally, the performance outcome may be based on the hardware and network resources available, as well as the systems administrator having knowledge of the data center's design, and the ability to performance tune the network.

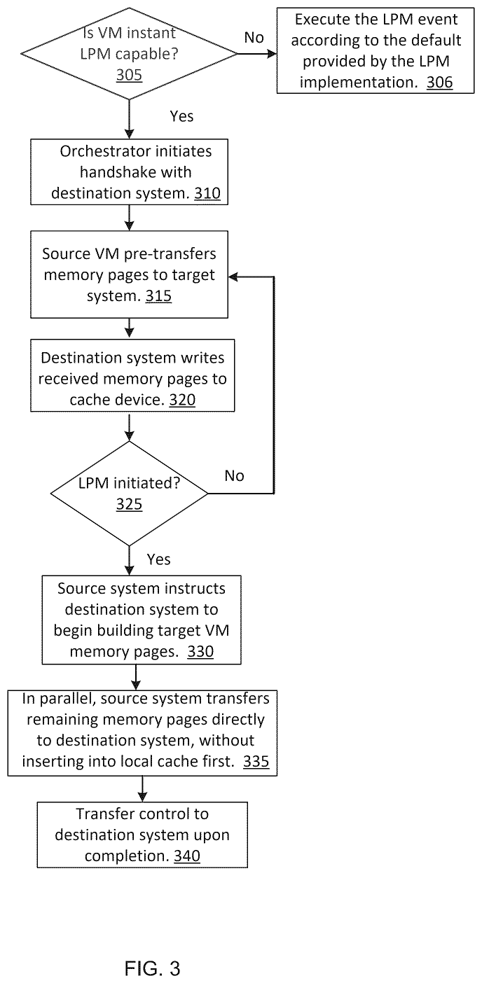

FIG. 3 is an operational flowchart illustrating a LPM operation where the VM is instant LPM capable according to at least one embodiment.

At 305, as part of starting a source VM 200, the orchestrator 270 checks for the presence of the instant LPM capable indicator in the source VM 200 configuration profile. If the source VM 200 is not instant LPM capable, no pre-transfer activity is performed. In that case, when the hypervisor 260 receives an LPM event command, the LPM command is executed according to the default provided by the LPM implementation.

If, at 305, the source VM is instant LPM capable, then at 310 the orchestrator 270 initiates a handshake with the destination computer 101. As part of the handshake, the orchestrator instructs the hypervisor 260 on the destination computer 101 to initialize the local cache 225 and make it available to the destination computer 101 VIOS 250.

At 315, the hypervisor 260 on the source computer 110 begins categorizing the memory pages assigned to the source VM 200 according to their activity in preparation for pre-transferring the least recently modified memory pages to the local cache 225. Periodically, the VIOS 250 on the source computer 101 polls its hypervisor 260 to begin pre-transfer of the least recently modified memory pages to the local cache 225.

At 320, the VIOS 250 on the destination computer 101 receives the pre-transferred pages and writes them to the local cache 225.

At 325, if the LPM event is not initiated, then the process returns to 315, where the VIOS 250 on the source computer 101 continues to periodically poll its hypervisor 260 for any additional memory pages to pre-transfer.

If, at 325 the LPM event is initiated, then at 330 the hypervisor 260 on the source computer 101 notifies the hypervisor 260 on the destination computer 101, which in turn, instructs the VIOS 250 on the destination computer 101 to begin building the destination VM 200. Building may comprise accessing the repository of configuration files as stored on the orchestrator 270, and allocating the necessary virtual resources, such as processors, memory, and devices. The VIOS 250 then begins building the destination VM 200 memory pages using the local cache 225.

At 335, in parallel to building the destination VM 200 from the local cache 225, the VIOS 250 on the source computer 101 sends any remaining source VM 200 memory pages to the destination computer 101 where the VIOS 250 there writes them to the local cache 225.

At 340, upon completion of building the destination VM 200 memory pages, the hypervisor 260 activates the destination VM 200 and deactivates the source VM 200.

It may be appreciated that FIGS. 2 and 3 provide only an illustration of one embodiment and do not imply any limitations regarding how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

What is claimed is:

1. A computer-implemented method for a non-disruptive live partition mobility (LPM) event, the computer-implemented method comprising:
verifying, by an orchestrator, that a profile definition of a source virtual machine (VM) indicates the source VM is instant live partition mobility (LPM) capable;
based on the source VM being instant LPM capable, instructing by the orchestrator, a hypervisor of a source computer to initiate a handshake procedure with a hypervisor of a destination computer;
in response to the instant LPM capable VM being activated, the hypervisor of the source computer enabling the source virtual input/output server (VIOS) to initiate a continuous pre-transfer of source VM memory pages to a virtual input/output server (VIOS) on the destination computer, wherein the VIOS on the destination computer writes the pre-transferred source VM memory pages to a local cache on the destination computer;
upon initiating an LPM event on the source computer, the hypervisor of the destination computer receiving an instruction to build a destination VM;
in parallel to the build of the destination VM, continuing to send remaining source VM memory pages directly to the destination computer;
prior to inserting a remaining source VM memory page into the destination VM, searching the local cache for a duplicate memory page;
invalidating as stale the duplicate memory page in the local cache, and inserting the remaining source VM memory page into the destination VM; and
upon completion of the build of the destination VM, terminating the LPM event.

2. The method of claim 1, wherein the terminating the LPM event further comprises:
activating the destination VM;
deactivating the source VM; and
releasing virtual resources of the source VM.

3. The method of claim 1, wherein the local cache is a high-speed persistent storage device connected to the VIOS on the destination computer, and wherein the local cache is dedicated to storing the pre-transferred memory pages of one or more source VMs.

4. The method of claim 1, wherein the instruction to build the destination VM further comprises accessing a repository of configuration files on the orchestrator, allocating virtual resources as specified in the destination VM configuration file and instructing the VIOS on the destination computer to build the destination VM memory pages using the local cache.

5. The method of claim 1, wherein the pre-transferred source VM memory pages are least recently modified memory pages.

6. The method of claim 1, wherein the local cache has a capacity at least as large as the size of the source VM memory pages.

7. The method of claim 1, wherein the local cache is partitioned to support the memory pages of more than one source VM simultaneously.

8. The method of claim 1, wherein the LPM event for a non-instant LPM capable source VM is performed using a default behavior of the source computer and the destination computer, and wherein the source computer includes a combination of instant LPM and non-instant LPM capable source VMs.

9. A computer program product for a non-disruptive live partition mobility (LPM) event, wherein the computer program product comprises a computer readable storage medium having program instructions embodied therewith, the program instructions executable by a processing unit to cause the processing unit to perform a method comprising:
verifying, by an orchestrator, that a profile definition of a source virtual machine (VM) indicates the source VM is instant live partition mobility (LPM) capable;
based on the source VM being instant LPM capable, instructing by the orchestrator, a hypervisor of a source computer to initiate a handshake procedure with a hypervisor of a destination computer;
in response to the instant LPM capable VM being activated, the hypervisor of the source computer enabling the source virtual input/output server (VIOS) to initiate a continuous pre-transfer of source VM memory pages to a virtual input/output server (VIOS) on the destination computer, wherein the VIOS on the destination computer writes the pre-transferred source VM memory pages to a local cache on the destination computer; upon initiating an LPM event on the source computer, the hypervisor of the destination computer receiving an instruction to build a destination VM;
in parallel to the build of the destination VM, continuing to send remaining source VM memory pages directly to the destination computer;
prior to inserting a remaining source VM memory page into the destination VM, searching the local cache for a duplicate memory page;
invalidating as stale the duplicate memory page in the local cache, and inserting the remaining source VM memory page into the destination VM; and
upon completion of the build of the destination VM, terminating the LPM event.

10. The computer program product of claim 9, wherein the terminating the LPM event further comprises:
activating the destination VM;
deactivating the source VM; and
releasing virtual resources of the source VM.

11. The computer program product of claim 9, wherein the local cache is a high-speed persistent storage device connected to the VIOS on the destination computer, and wherein the local cache is dedicated to storing the pre-transferred memory pages of one or more source VMs.

12. The computer program product of claim 9, wherein the instruction to build the destination VM further comprises accessing a repository of configuration files on the orchestrator, allocating virtual resources as specified in the destination VM configuration file and instructing the VIOS on the destination computer to build the destination VM memory pages using the local cache.

13. The computer program product of claim 9, wherein the pre-transferred source VM memory pages are least recently modified memory pages.

14. The computer program product of claim 9, wherein the local cache has a capacity at least as large as the size of the source VM memory pages.

15. The computer program product of claim 9, wherein the local cache is partitioned to support the memory pages of more than one source VM simultaneously.

16. The computer program product of claim 9, wherein the LPM event for a non-instant LPM capable source VM is performed using a default behavior of the source computer and the destination computer, and wherein the source computer includes a combination of instant LPM and non-instant LPM capable source VMs.

17. A computer system for a non-disruptive live partition mobility (LPM) event, the computer-implemented method comprising:
one or more processors;
a memory coupled to at least one of the processors;
a set of computer program instructions stored in the memory and executed by at least one of the processors to perform actions of:
verifying, by an orchestrator, that a profile definition of a source virtual machine (VM) indicates the source VM is instant live partition mobility (LPM) capable;
based on the source VM being instant LPM capable, instructing by the orchestrator, a hypervisor of a source computer to initiate a handshake procedure with a hypervisor of a destination computer;
in response to the instant LPM capable VM being activated, the hypervisor of the source computer enabling the source virtual input/output server (VIOS) to initiate a continuous pre-transfer of source VM memory pages to a virtual input/output server (VIOS) on the destination computer, wherein the VIOS on the destination computer writes the pre-transferred source VM memory pages to a local cache on the destination computer, and wherein the pre-transferred source VM memory pages are least recently modified memory pages;
upon initiating an LPM event on the source computer, the hypervisor of the destination computer receiving an instruction to build a destination VM;
in parallel to the build of the destination VM, continuing to send remaining source VM memory pages directly to the destination computer;
prior to inserting a remaining source VM memory page into the destination VM, searching the local cache for a duplicate memory page;
invalidating as stale the duplicate memory page in the local cache, and inserting the remaining source VM memory page into the destination VM; and
upon completion of the build of the destination VM, terminating the LPM event.

18. The computer system of claim 17, wherein:
the local cache is a high-speed persistent storage device connected to the VIOS on the destination computer;
the local cache is dedicated to storing the pre-transferred memory pages of one or more source VMs;
the local cache has a capacity at least as large as the size of the source VM memory pages; and
the local cache is partitioned to support the memory pages of more than one source VM simultaneously.

19. The computer system of claim 17, wherein the instruction to build the destination VM further comprises accessing a repository of configuration files on the orchestrator, allocating virtual resources as specified in the destination VM configuration file and instructing the VIOS on the destination computer to build the destination VM memory pages using the local cache.

20. The computer system of claim 17, wherein the LPM event for a non-instant LPM capable source VM is performed using a default behavior of the source computer and the destination computer, and wherein the source computer includes a combination of instant LPM and non-instant LPM capable source VMs.
